(19) United States
(12) Patent Application Publication
(10) Pub. No.: US 2020/0302643 A1
(43) Pub. Date: Sep. 24, 2020

(54) SYSTEMS AND METHODS FOR TRACKING

(71) Applicant: Oblong Industries, Inc., Los Angeles, CA (US)

(72) Inventors: Ayon Sen, Los Angeles, CA (US); John Stephen Underkoffler, Los Angeles, CA (US)

(21) Appl. No.: 16/823,600

(22) Filed: Mar. 19, 2020

Related U.S. Application Data
(60) Provisional application No. 62/822,593, filed on Mar. 22, 2019.

(51) Int. Cl. G06T 7/73

(52) U.S. Cl. CPC G06T 7/74; G06T 2207/30244

(57) ABSTRACT

Systems and methods for determining position and orientation of an object using captured images.

### CROSS-REFERENCE TO RELATED APPLICATIONS

This application claims priority to U.S. Provisional Application No. 62/822,593 filed 22 Mar. 2019, which is incorporated herein in its entirety by this reference.

### TECHNICAL FIELD

This invention relates generally to the object tracking field, and more specifically to new and useful systems and methods for tracking an electronic device in the object tracking field.

### BACKGROUND

There is a need in the object tracking field to create a new and useful system and method for tracking an electronic device. This invention provides such new and useful systems and methods.

### BRIEF DESCRIPTION OF THE FIGURES

FIGS. 1A-B are schematic representations of a system, in accordance with embodiments.

FIG. 2 is a flowchart representation of a method, in accordance with embodiments.

FIG. 3 is a flowchart representation of a method, in accordance with embodiments.

FIG. 4 is a schematic representation of tags, in accordance with embodiments.

FIG. 5 is a schematic representation of an exemplary infrared image, in accordance with embodiments.

FIG. 6 is a schematic representation of an image, in accordance with embodiments.

FIG. 7 is a schematic representation of points, in accordance with embodiments.

FIG. 8 is a schematic representation of tags, in accordance with embodiments.

### DESCRIPTION OF THE PREFERRED EMBODIMENTS

The following description of the preferred embodiments is not intended to limit the disclosure to these preferred embodiments, but rather to enable any person skilled in the art to make and use embodiments disclosed herein.

### 1. OVERVIEW

Embodiments herein include tracking systems and methods.

In some variations, the system includes at least one of: a tag (e.g., 121-123), an electronic device (e.g., 110), a camera (e.g., 112), a display device (e.g., 120), a tracking system (e.g., 130), and an application computing device (e.g., 140).

The method can include at least one of: capturing an image of a tag using a camera (e.g., S210); and determining position and orientation of an object (e.g., of the camera, etc.) (e.g., S220).

In some variations, the image of the tag is used along with a determined reference direction to determine the position and orientation. In some variations, each tag has four tag elements that identify respective ends of two non-overlapping linear elements, and each linear element has a known length. The two linear elements of a tag can be collinear, parallel, or angled. In some implementations, each tag has only four tag elements. However, any suitable tag arrangement can be used to determine position and orientation.

In some variations, the system can use any combination of collinear, parallel, and angled tags to determine position and orientation.

Position and orientation of the object can be used to identify a display device (e.g., used by a collaboration system), identify user selection (e.g., of output displayed by a display device of the collaboration system), or identify a command. However, position and orientation of the object can be used for any suitable purpose.

### 2. BENEFITS

Variations of this technology can afford several benefits and/or advantages.

First, variations of the technology can result in a reduced cost and/or complexity of tags used to determine position and orientation, since the technology enables tracking by recognizing tags having as little as four elements. For example, for tags using LED elements, such a design results in reduced number of LEDs, as compared to tracking systems which involve tags with more than two LEDs.

Second, variations of the technology provide tracking by using tags with a colinear bar configuration. Such a configuration is useful in multi-display system in which two or more displays are arranged together to provide a continuous display user experience. Such a colinear bar configuration can be arranged on the top or bottom border area of a display, thereby reducing obstruction of the display area as compared to tags that have an angled arrangement in which tag elements lie somewhere between individual display devices.

Third, by virtue of embodiments disclosed herein, a pose of the electronic device can be determined from a single frame of image data (e.g., an image of a tag) and information from an accelerometer or IMU (e.g., an accelerometer or IMU included in the electronic device).

Fourth, by virtue of embodiments disclosed herein, a tag can be identified from a single frame of image data and information (e.g., reference direction) from an accelerometer or IMU (e.g., an accelerometer or IMU included in the electronic device). In other words, a tag can be identified without knowledge of 3D coordinate information of the tag in a world coordinate system. Once identified, information related to an identified tag can be retrieved (e.g., from a database).

### 3. SYSTEM

The system can be a collaboration system, a kiosk, a computing system, an appliance, a teleconferencing system, a presentation system, a smart office, an entertainment system, a vehicle control system, a robot control system, an industrial control system, or any suitable type of system that involves uses of tracking of 3-space position and orientation of an object by using tags.

In some variations, the system 100 includes at least one of: a tag (e.g., 121-123, 161, 162, 151, 152), an electronic device (e.g., 110), a camera (e.g., 112), a display device (e.g., 120, 150, 160), a tracking system (e.g., 130), and an application computing device (e.g., 140). The system can optionally include one or more of a communication interface 114, an infrared (IR) filter 111, an input device 116, an image processor 113, and an inertial measurement unit 115. One or more of the components of the system 100 can be included in the electronic device. However, the system can be configured in any suitable type of arrangement.

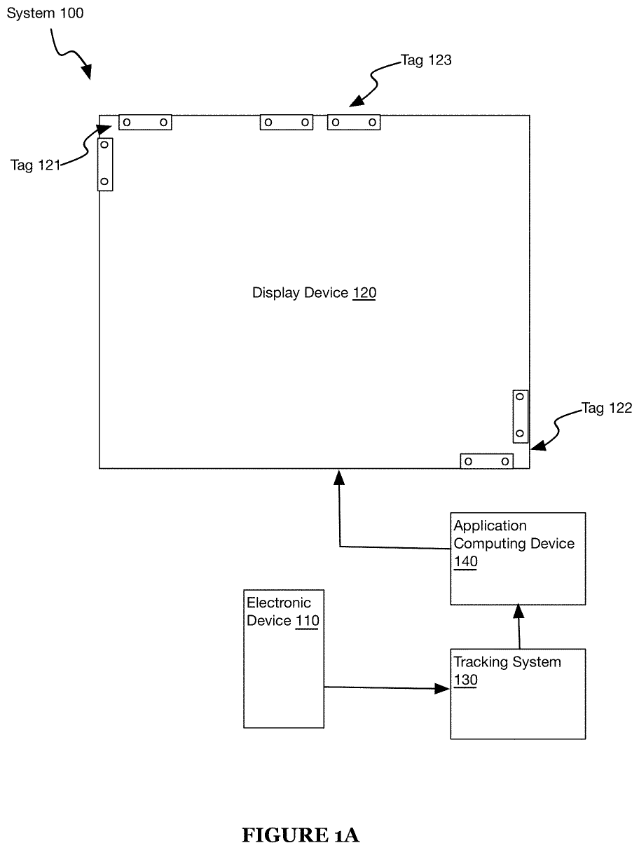

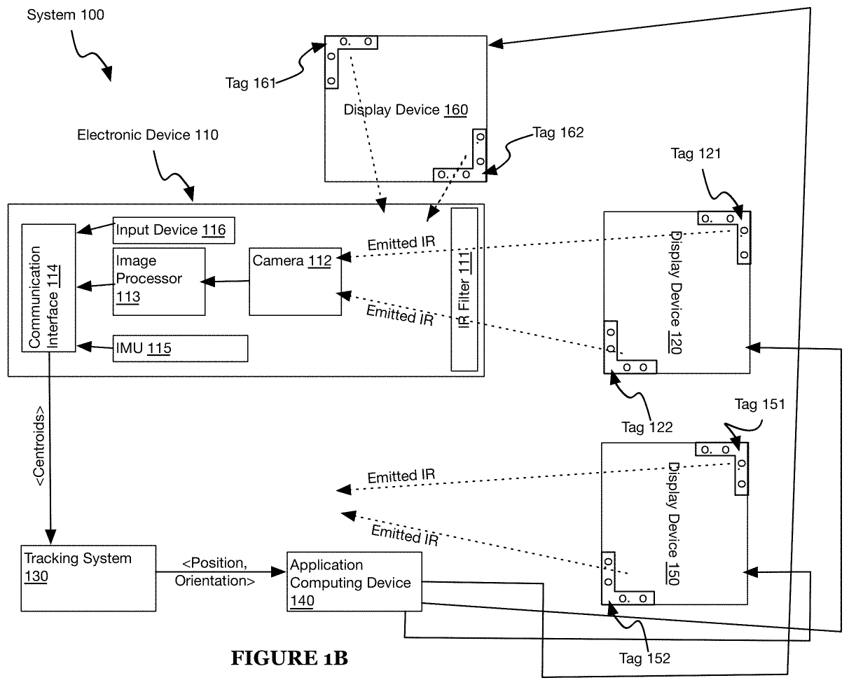

FIGS. 1A-B are schematic representations of a system, in accordance with embodiments.

In some variations, the electronic device (e.g., 110) functions to control an application (e.g., an application provided by the application computing device 140) based on movement of the electronic device. The electronic device can be a user input wand, a mobile computing device (e.g., tablet, phone, laptop, wearable computing device, etc.), or any other suitable type of electronic device.

In some variations, the electronic device includes one or more of a camera, an accelerometer, an Inertial Measurement Unit (IMU), an image processor, an infrared (IR) filter, a CPU, a display device, a memory, a storage device, an audible output device, an audio sensing device, a haptic feedback device, sensors, a GPS device, a WiFi device, a biometric scanning device, an input device, and a power source (e.g., a battery). In some variations, the electronic device includes an IMU that further includes an accelerometer. In some variations, one or more components included in the electronic device are communicatively coupled via a bus. In some variations, one or more components included in the electronic device are communicatively coupled to an external system (e.g., a tracking system 130, an application computing device 140) via the communication interface (e.g., 114).

In some variations, the camera 112 is communicatively coupled to the image processor 113. In some variations, the image processor 113 is communicatively coupled to the communication interface 114. In some variations, the input device 116 is communicatively coupled to the communication interface 114. In some variations, the IMU 115 is communicatively coupled to the communication interface 114. In some variations, the IMU 115 is constructed to send IMU data to the tracking system 130 via the communication interface 114.

The camera 112 functions to generate image data (e.g., IR image data, visual light image data, etc.). In some variations, the camera includes a sensor constructed to sense IR light and visible light. In some variations, the IR filter is constructed to filter out visible light and pass IR light to the camera 112.

The communication interface 114 functions to communicate data between the electronic device and another device (e.g., a tracking system 130, an application computing device 140). The communication interface 114 can be any suitable type of wireless interface (e.g., Bluetooth) or wired interface.

The input device 116 functions to receive user input. In some variations, the input device 116 includes at least one of buttons and a touch screen input device (e.g., a capacitive touch input device, etc.).

The image processor 113 functions to perform image processing. The image processor 113 can be a FPGA, an ASIC (Application Specific Integrated Circuit), a programmable microprocessor, or any suitable type of image processor. In some variations, the image processor 113 is constructed to perform real-time image edge detection. In some variations, the image processor 113 is constructed to perform real-time image feature detection. In some variations, the image processor 113 is constructed to perform real-time image feature extraction.

In some variations, each display device (e.g., 120, 150, 160) functions to display image data (e.g., rendered display output of an application, images, text, etc.). In some variations, at least one display (e.g., 120, 150, 160) includes at least one tag (e.g., 121, 122, 151, 152, 161, 162). In some variations, each display device includes two tags (e.g., 121, 122, 151, 152, 161, 162). In some variations, each display device 120, 150, 160 includes four tags.

In some variations, each tag includes two or more tag elements. Tag elements can include light (e.g., visible, invisible, ultraviolet infrared, etc.) emitting elements (e.g., light emitting diodes, display pixels, etc.), light reflecting elements, or any suitable type (or combination of types) of tag element that can be identified in an image sensed by a sensor (e.g., a camera).

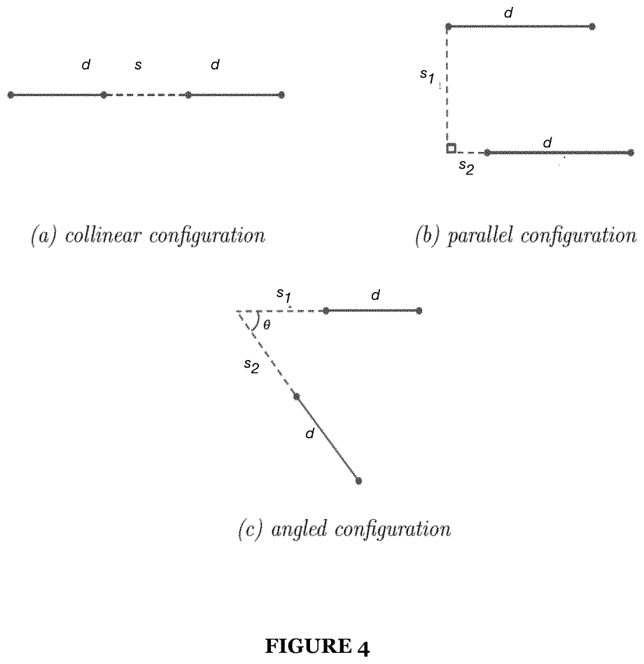

In some variations, each tag includes four tag elements that identify respective ends of two non-overlapping linear elements (bars), and each linear element has a known length (e.g., d shown in FIG. 4). In some variations, each tag includes only four tag elements.

In some variations, each bar is constructed using a pair of tag elements mounted at the extreme edges of a substrate. The substrate can be a metal plate, a polymer substrate, a semiconductor substrate, a substrate embedding a display device, or any suitable type of substrate.

In a first example, two non-overlapping linear elements are collinear, and a distance between the two non-overlapping linear elements is the tag identifier. In a second example, the two non-overlapping linear elements are parallel, and a pair of distances between the non-overlapping linear elements is the tag identifier. In a third example, the two non-overlapping linear elements are angled, and a pair of distances between the non-overlapping linear elements and a known angle between the two non-overlapping linear elements is the tag identifier.

Several configurations of tags are shown in FIG. 4. In a first variation, a collinear tag ((a), shown in FIG. 4) includes two collinear bars and is parameterized by s, the distance between the two bars. In a second variation, a parallel tag ((b) shown in FIG. 4) includes two parallel (but non-collinear) bars and is parameterized by the pair of distances (s1, s2). In a third variation, an angled tag ((c) shown in FIG. 4) includes two angled bars, and is parameterized by a pair of distances (s1, s2), and a known angle θ. In some variations, a bar is shared by two or more tags.

In some variations, a bar includes more than two tag elements. In variations embodiments, at least two bars include a different number of tag elements. In some variations, a number of bar elements included in a bar can identify information about the bar, such as, for example, a bar direction. In some variations, positioning of one or more tag elements between end bar elements (e.g., a bar with 3 or more bar elements) can identify information about the bar, such as, for example, a bar direction.

In some variations, at least one tag is attached to a corresponding display device. In some variations, at least one tag is included in a bezel of the corresponding display device. In some variations, at least one tag is included in the display area of the corresponding display device. In some embodiments, in addition to emitting Red, Green and Blue light, at least one pixel of at least one display device also emits IR light, and sets of pixels of the display device form a tag. In some embodiments, in addition to emitting Red, Green and Blue light, a plurality of pixels of at least one display device also emits IR light, and sets of IR emitting pixels of the display device form a tag.

The tracking system 130 functions to track movement (e.g., of the electronic device, the camera 112) for control of the application (e.g., executed by the application computing device 140). In some variations, the tracking system 130 is constructed to receive centroid data from the electronic device 110 via the communication interface 114, process the centroid data to generate an absolute 3-space position of the electronic device (e.g., 110) and an orientation of the electronic device with respect to a display device (e.g., 120) of a spatial operating environment, and provide the absolute 3-space position and the orientation to the application computing device 140.

In some variations, the tracking system 130 includes one or more of a camera, an accelerometer, an Inertial Measurement Unit (IMU), an image processor, an infrared (IR) filter, a CPU, a display device, a memory, a storage device, an audible output device, an audio sensing device, a haptic feedback device, sensors, a GPS device, a WiFi device, a biometric scanning device, an input device, and a power source (e.g., a battery). In some variations, the tracking system 130 includes an IMU that further includes an accelerometer. In some variations, one or more components included in the tracking system 130 are communicatively coupled via a bus. In some variations, one or more components included in the tracking system 130 are communicatively coupled to an external system (e.g., the electronic device 110, the application computing device 140, etc.) via the communication interface of the tracking system 130.

The application computing device 140 functions to provide an application. In some variations, the application computing device is a spatial application computing device that is constructed to receive the absolute 3-space position and the orientation from the tracking system 130. In some variations, a spatial application provided by the spatial application computing device 140 processes the position and orientation information to update application state. In some variations, the spatial application provided by the spatial application computing device 140 generates display data based on the position and orientation information and provides the generated display data to at least one display device (e.g., 120, 150, 160) of the spatial operating environment.

In some variations, the application computing device 140 includes one or more of a camera, an accelerometer, an Inertial Measurement Unit (IMU), an image processor, an infrared (IR) filter, a CPU, a display device, a memory, a storage device, an audible output device, an audio sensing device, a haptic feedback device, sensors, a GPS device, a WiFi device, a biometric scanning device, an input device, and a power source (e.g., a battery). In some variations, the application computing device 140 includes an IMU that further includes an accelerometer. In some variations, one or more components included in the application computing device 140 are communicatively coupled via a bus. In some variations, one or more components included in the application computing device 140 are communicatively coupled to an external system (e.g., the tracking system 130, the electronic device 110, etc.) via the communication interface of the application computing device 140.

In some variations, a single computing device performs the processes of the tracking system 130 and a spatial application computing device 140 as described herein.

In some variations, the tracking system 130 is communicatively coupled to the application computing device 140. In some variations, the tracking system 130 is communicatively coupled to the application computing device 140 via a network device. In some variations, the application computing device 140 is communicatively coupled to the display devices 120, 150 and 160. In some variations, the electronic device 110 is communicatively coupled to the tracking system 130. In some variations, the electronic device 110 is communicatively coupled to the tracking system 130 via a network device. In some variations, the electronic device 110 is communicatively coupled to the tracking system 130 via a wired interface. In some embodiments, the electronic device 110 is communicatively coupled to the tracking system 130 via a wireless interface (e.g., Bluetooth).

### 4. METHOD

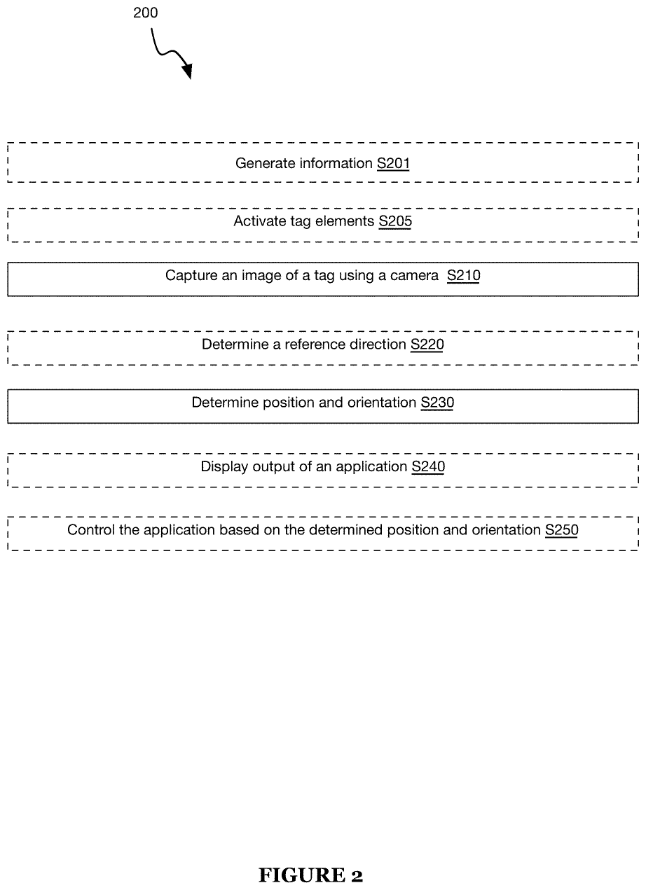

In some variations, the method (e.g., 200 shown in FIG. 2) includes at least one of: capturing an image of a tag using a camera (S210); and determining position and orientation (e.g., pose) of an object (e.g., camera, etc.) (S230). In some variations, the method includes one or more of: generating collaboration information (S201); activating one or more tag elements (S205); determining a reference direction (S220); displaying output of an application (S240); and controlling the application (S250).

In some variations, at least one component of the system 100 performs at least a portion of the method.

The method 200 can be performed (e.g., executed, implemented, etc.) in real-time or near-real time. The method is preferably iteratively performed at a predetermined frequency (e.g., every millisecond, at a sampling frequency, etc.), but can alternatively be performed in response to occurrence of an event.

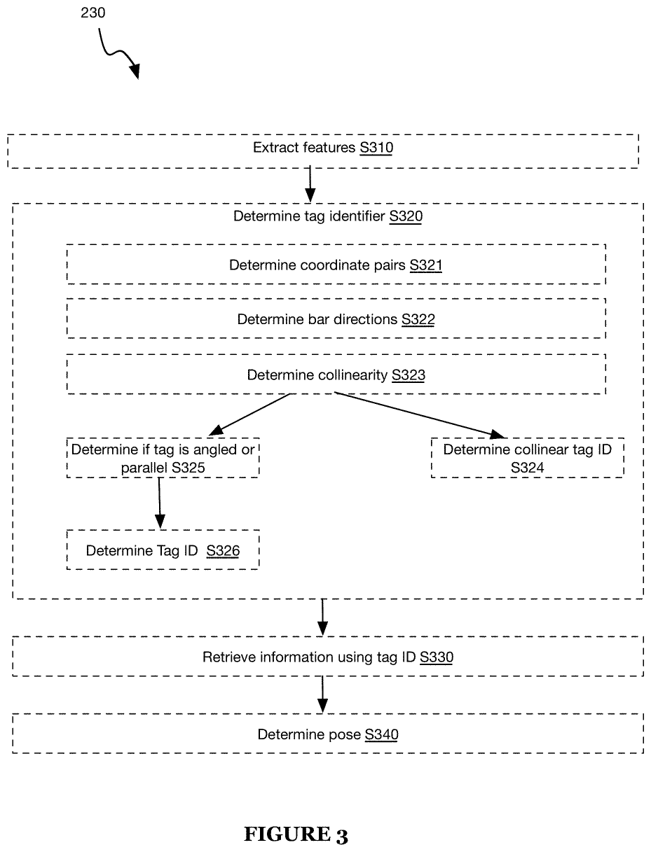

FIGS. 2 and 3 are flowchart representations of a method, in accordance with embodiments.

S201 functions to generate information used to determine position and orientation at S230.

In some variations, S201 functions to generate tag information that is retrieved by using a tag identifier (e.g., retrieved at S330 shown in FIG. 3). In some variations, S201 includes determining 3D coordinates of each tag in a room of the system (e.g., 100) (in a world coordinate system), capturing images of each tag in the room (e.g., by using the electronic device 110, camera 112, or any other suitable device), generating a tag identifier for each tag by using a captured image of the tag and accelerometer information (or IMU information) (as described herein), and storing the 3D coordinates in association with the respective tag identifiers (e.g., in a calibration database, file, object, etc.). In some variations, determining 3D coordinates of each tag includes performing a bundle adjustment process. However, 3D coordinates of each tag can otherwise be determined.

In some variations, in a world coordinate system where the y-direction corresponds to gravity and x and z are two directions perpendicular to y (and to each other), “Vertical” can be used to refer to a direction aligned with the vertical reference direction and “horizontal” can be used to refer to any direction perpendicular to the vertical reference direction. In the case of a tag in the xz plane, the tag ID is generated by performing the process of determining a tag ID for a non-collinear tag (e.g., parallel tag, angled tag), as described herein for S236. In some variations, all angled tags in the xy plane can be identified without a priori knowledge of the angle between bars, and the angle between bars can be calculated from the camera image. In some variations, in the case of a tag in the xz plane, the tag ID is generated by performing the process of determining a tag ID for a non-collinear tag (e.g., parallel tag, angled tag), as described herein for S326, regardless of whether the tag is collinear or not.

In some variations, because the parameters that characterize the tags are physical distances (e.g., s1, s2), many instances of each tag can be generated such that all of the tags can be distinguished from one another. Depending on the range of distances that the camera is expected to view the tags from, a minimum resolvable distance can be empirically derived. For example, if a collinear tag with s=sₐ and another collinear tag with s=s_{b} are placed in the same tracking volume, one can determine the minimum value of Δs=|sₐ−s_{b}| such that the two distances can be reliably distinguished (taking image processing noise, sensor noise, and calibration inaccuracy into account). Then all tags can be generated such that their parameter values are of the form sₐ+N Δs, where N is an integer; the difference in parameter values between any pair of tags that can be viewed in the same system will be at least a multiple of Δs. In some variations, the following values are used: d=130 mm, Δs=50 mm, and sₐ=0.93 m. However, other values of d, Δs, and sₐ can be used.

In some variations, any suitable process can be used to determine physical distances (e.g., s1, s2) for tags used in the system 100.

S205 functions to activate one or more tag elements. In a first variation, S205 functions to activate one or more emitting elements (e.g., light emitting diodes, display pixels, etc.). In a first example, emitting elements are electrically activated by supplying power (or an electrical control signal) to the emitting element (e.g., by powering a light emitting diode, etc.). In a second example, emitting elements are mechanically activated by activating a shutter to expose the emitting element. However, emitting elements can be otherwise activated. In a second variation S205 functions to activate one or more reflecting elements. In a first example, reflecting elements are electrically activated by supplying power (or an electrical control signal) to the reflecting element. In a second example, reflecting elements are mechanically activated by activating a shutter to expose the reflecting element. However, reflecting elements can be otherwise activated.

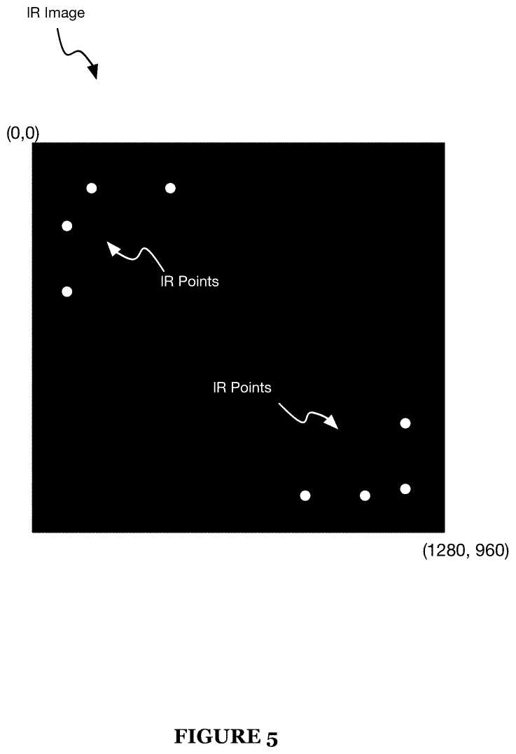

S210 functions to capture an image of at least one tag by using a camera. The image can be a still image, a video frame, and the like. In a first example, the image is captured using an IR filter, such that IR light is represented by the image, and other light is filtered out from the image by the IR filter. For example, an IR image of a tag having IR emitters can include a black background with blobs representing the light emitted from each IR emitter (e.g., as shown in FIG. 5). In a second example, the image is captured without using an IR filter, such that visible light is captured in the image. However, any suitable type of image capable of identifying tag elements can be captured by using any suitable type of sensor.

In some variations, the camera is a tracking camera. In some variations, the camera is included in an electronic device (e.g., 110) for the system 100.

In a first example, at least one imaged tag is a display device tag (e.g., attached to a display device, embedded within a bezel of a display device, embedded within a display area of the display device, etc.). In a second example, at least one imaged tag is a tag attached an object that is not a display device (e.g., a whiteboard, a corkboard, a trash can, a chair, etc.). In a third example, at least one imaged tag is positioned on a stand (e.g., a tripod). In a fifth example, at least one imaged tag is suspended (e.g., by a string, cable) (e.g., from a ceiling, etc.).

Imaged tags can include any suitable type of tag described herein. In some variations, at least one imaged tag includes four tag elements that identify respective ends of two non-overlapping linear elements, and each linear element has a known length. A first set of two of the tag elements identify the first linear element and a second set of two of the tag elements identify the second linear element. The first and second linear elements have a same, known length. In a first example, the at least one tag includes only the four tag elements. In a second example, the at least one tag includes the four tag elements, and one or more additional tag elements. The additional tag elements can be arranged on respective linear elements between the ends of the linear elements. However, in some variations, imaged tags can include any suitable type of tag that can be used to determine position and orientation, as described herein.

S220 functions to determine a reference direction. In some variations, the reference direction is a vertical vector in a world coordinate system (e.g., a world reference direction) of the system 100. In some variations, the reference direction is a gravity vector. In some variations, the reference direction is a direction identified by at least one of an accelerometer and an IMU (e.g., included in an electronic device 110, included in a camera 112, or otherwise included in the system 100). In some variations, the reference direction is a direction identified by a single measurement of the accelerometer (or IMU) captured at the time that the image data of S210 is captured. In some variations, the camera is stationary (e.g., external to the electronic device, or included in a stationary electronic device), the tags are non-stationary (e.g., attached to a moving object), and the world reference direction is a direction identified by a known pose of the camera.

S230 functions to determine position and orientation (e.g., pose) of an object. In some variations, the position and orientation is 3-space position and orientation. In some variations, the position and orientation is a position and orientation in the world coordinate system of the system 100. The object can be an electronic device (e.g., 110), a camera (e.g., 112), and the like. In some variations, the object is a hand. In some variations, at least one of an electronic device (e.g., 110) and a tracking system (e.g., 130) determines the position and orientation. However, any suitable component (or combination of components) of the system 100 can perform S230.

In some variations, the position and orientation is determined by using the captured image (e.g., in the case of a collinear tag). In some variation, the position and orientation is determined by using the reference direction and the captured image (e.g., in the case of a parallel or angled tag).

In some variations, position and orientation are tracked over time by using any combination of collinear, parallel, and angled tags. For example, a display device can include angled tags on the corners, and collinear tags on the edges (between corners). A position and orientation of the object can be tracked over time, such as at a first point in time when the camera is imaging an angled tag, and then at a second point in time when the camera is imaging a collinear tag. For example, a large display wall can include angled tags on the corners, and collinear tags along the edges, such that tags do not interfere with the display area of the display wall or extend beyond the outer portion of the display wall bezel.

In some variations, S230 can include one or more of S310, S320-S326, S330, and S340 shown in FIG. 3.

In some variations, S310 functions to extract from the image information that can be used to determine position and orientation. In some variations, the image corresponds to at least one tag (as described herein).

S310 can include identifying blobs in the image. In some variations, the blobs correspond to tag elements (as described herein) (e.g., light or electromagnetic radiation emitted or reflected by a tag element). S310 can include determining centroids for each blob. S310 can include extracting 2D (two dimensional) coordinates of each centroid.

In a first variation, the image is an image generated from visible light, the blobs are extracted by performing at least one of an object recognition process, an image feature extraction process, an edge detection process, and a feature detection process, and the 2D coordinates of centroids of these blobs are determined. In a second variation, the image is an image generated from IR light (e.g., as shown in FIG. 5), such that the image is a dark image with bright dots (blobs) corresponding to IR light emitted by (or reflected by) a tag element, and the 2D coordinates of centroids of these dots are determined. In some variations, the image processor (e.g., 113) determines the 2D coordinates of the blobs in the image frame. In some variations, the tracking system receives the frame of image data generated by the camera and a processor of the tracking system determines the 2D coordinates of the blobs in the image frame.

S310 can include using a computer vision module to determine 2D coordinates of centroids of blobs corresponding to tag elements. In some variations, each blob of the frame is determined by using a computer vision module. In some variations, each blob of the frame is determined by using the OpenCV (Open Source Computer Vision) library. In some variations, each 2D image coordinate of a centroid is determined by using a computer vision module. In some variations, each 2D image coordinate of a centroid is determined by using the OpenCV (Open Source Computer Vision) library.

However, the 2D coordinates can be otherwise determined from the image captured at S210.

S320 functions to determine at least one tag identifier that can be used to retrieve tag information.

In some variations, S320 includes determining at least one tag identifier based on the 2D coordinates extracted at S210. In some variations, S320 includes identifying groups of 2D coordinates that correspond to a tag. In some variations, any suitable type of clustering or grouping process can be used to identify 2D coordinates that correspond to a tag. In a case where each tag has n tag elements, groups of n 2D coordinates are identified. In some variations, each tag includes 4 tag elements, and thus S320 includes identifying groups of four 2D coordinates that correspond to a tag. In some variations, a first 2D coordinate is selected and (n−1) other coordinates nearest to the selected first 2D coordinate are selected for inclusion in a group of 2D coordinates for a tag. In some variations, a first 2D coordinate is selected and three other coordinates nearest to the selected first 2D coordinate are selected for inclusion in a group of 2D coordinates for a tag that includes four tag elements. In some variations, S320 includes assigning each 2D coordinate to a group (tag group) representing n 2D coordinates of a common tag. A tag group is a group of 2D coordinates (extracted from an image as described herein) that are determined to belong to a single tag. In some variations, a tag group includes 2D coordinates for each bar of the tag. For example, for a tag having two bars (each bar having two tag elements) the tag group includes four 2D coordinates (two 2D coordinates for each of the two bars).

In a first example, the captured image is used to identify the tag identifier (e.g., for a collinear tag). In a second example, the captured image and the reference direction are used to identify the tag identifier (e.g., for a parallel or angled tag). The tag identifier can include one or more of a distance and an angle. In a first example, for a collinear tag, the tag identifier is a distance (e.g., s shown in FIG. 4) between the two non-overlapping linear elements of the collinear tag. In a second example, for a parallel tag, the tag identifier is a pair of distances (e.g., s1 and s2 shown in FIG. 4). In a third example, for an angled tag, the tag identifier is a pair of distances and an angle (e.g., s1 and s2 and Θ shown in FIG. 4). As an example, the first distance s1 can be a distance between an end of the first linear elements and an intersection point formed by extending the linear elements, and a second distance s2 can a distance between an end of the second linear elements and the intersection point. The angle can be the angle formed between the two linear elements. In some variations, the angle is known (e.g., all tag angles can be 90 degrees, or any other known angle, etc.).

However, any suitable type of tag identifiers can be used.

In some variations, S320 includes S321.

S321 includes determining for each tag group, a coordinate pair {(x₁, y₁), (x₂, y₂)} for each bar of the tag represented by the tag group. Each coordinate pair represents the positions of the two tag elements of a bar, one element arranged on each end of the bar (e.g., first bar end=(x₁, y₁), second bar end=(x₂, y₂)}). Since the tag elements at each end of the bar are separated by the same distance d, and since all tags are constructed as either, co-linear, parallel or perpendicular bars, line segments having these properties can be identified among the possible pairs of points in the tag group. In some variations, the points of the tag group are grouped into pairs according to proximity within the image, such that points that are close together are included in a coordinate pair. In some variations, any suitable type of clustering or grouping process can be used to group points (represented as 2D coordinates) of the tag group into pairs. However, any suitable type of process can be used to group the points of the tag group into pairs.

In some variations, at least one bar includes three or more tag elements, and in such a case, S321 includes, for a bar having more than two tag elements, determining a coordinate pair {(x₁, y₁), (x₂, y₂)}, wherein each coordinate pair represents one the positions of the two end tag elements of the bar (e.g., first bar end=(x₁, y₁), second bar end=(x₂, y₂)}).

In some variations, S320 includes S322.

S322 includes for each tag group, determining a direction of each bar represented by the coordinate pairs determined at block S321.

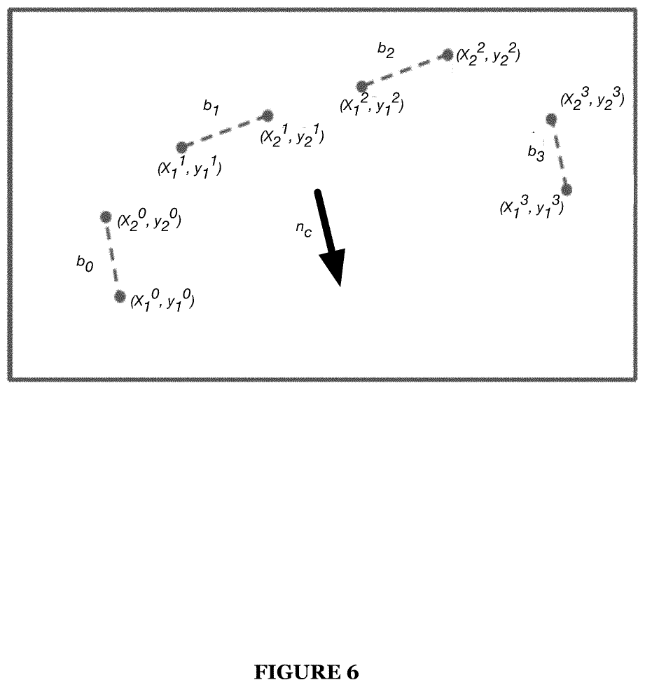

S322 functions to determine a direction each bar is pointing in the world coordinate system, by using the reference direction determined at S220. Each bar is identified by a coordinate pair {(x₁, y₁), (x₂, y₂)}. Information identifying the reference direction (e.g., world reference direction)((determined at S220) within the coordinate system of the image (and denoted as n_{c} herein) is determined. In some variations, the reference direction is projected onto the image. FIG. 6 shows an exemplary image (e.g., camera frame) with multiple tags and labeled centroids. Each bᵢ references a bar of a tag, and coordinates (x, y) represent 2D coordinates of centroids that correspond to an end of a bar. As shown in FIG. 6, n_{c} is the projection of the reference direction into the camera image (in the coordinate space of the camera image). As shown in FIG. 6, collinearity between bars is preserved in the image.

In some variations, each bar is arranged (e.g., in a room of the system 100) such that it is either aligned with the reference direction or perpendicular to the reference direction. In the case of a vertical reference direction (e.g., gravity vector), each bar is arranged in the room such that it is either vertical (vertical direction) or horizontal (horizontal direction) in the world coordinate system. As described herein, information identifying the reference direction within the coordinate system of the image (n_{c}) is determined, and the angle that the image of the bar (in the image coordinate system) makes with the vector n_{c} (e.g., a projected image of the vector n_{c}, coordinates of the vector n_{c} in the image coordinate space) determines if the bar is vertically or horizontally aligned with the reference direction in the world coordinate space. In some variations, if the angle that the image of the bar makes with the vector n_{c} is zero, and the vector is a vertical vector, then the bar is vertically aligned with the reference direction, whereas if the angle that the image of the bar makes with the vector n_{c} is not zero, and then the bar is horizontally aligned with the reference direction.

In some variations, S320 includes S323.

S323 includes for each tag group, determining whether the bars represented by the coordinate pairs (determined at block S321) are collinear (e.g., represent a collinear tag).

S323 functions to determine whether a tag is a collinear tag. In some variations (e.g., for a tag with four tag elements), S323 functions to determine whether four points (of a tag) are collinear. In some variations, responsive to a determination that the points of a tag group are collinear, the tag identifier for the tag represented by the tag group is computed by using the 2D coordinates of the tag group, and the known distance (e.g., d) between end tag elements of each bar (S324). In some variations, the tag identifier is computed according to the following equation (1):

$$( \frac{‖ {p}_{2} - {p}_{0} ‖ ‖ {p}_{3} - {p}_{1} ‖}{‖ {p}_{3} - {p}_{0} ‖ ‖ {p}_{2} - {p}_{1} ‖} ) = ( \frac{‖ {P}_{2} - {P}_{0} ‖ ‖ {P}_{3} - {P}_{1} ‖}{‖ {P}_{3} - {P}_{0} ‖ ‖ {P}_{2} - {P}_{1} ‖} ) = \frac{{( s + d )}^{2}}{s ( s + 2 d )} \qquad ( 1 )$$

wherein p₀, p₁, p₂, and p₃ are the four 2D coordinates of the tag group, d is the known distance between tag elements of each bar, and s is the tag identifier for a colinear tag.

In some variations, responsive to a determination that the points of a tag group are not collinear, then a determination is made as to whether the tag is a parallel tag or an angled tag (S325).

S325 functions to determine whether a tag is angled or parallel. In some variations, S325 includes determining an intersection point of the bars represented by the coordinate pairs of the tag group (determined at block S321) in the coordinate space of the image; in a case where the intersection point is further than a threshold distance from points in the image coordinate space that correspond to the bar line segments, the bars are determined to be parallel; in a case where the intersection point is closer than a threshold distance from points in the image coordinate space that correspond to the bar line segments, the bars are determined to be angled. However, any suitable process can be performed to determine whether a tag is angled or parallel.

In some variations, S320 includes S326.

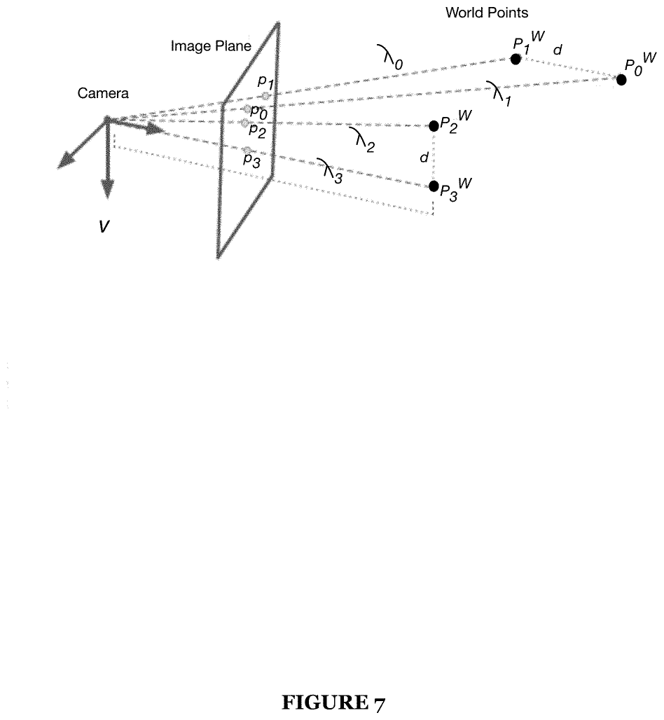

S326 functions to determine a tag ID for a non-collinear tag (e.g., parallel tag, angled tag). In some variations, an actual distance (from the center of the camera capturing the image) of each bar represented by the coordinate pairs of the tag group is determined. In some variations, an actual distance (from the center of the camera capturing the image) λᵢ of a bar end point Pᵢ^{W} is determined by using the corresponding 2D coordinate for the bar end point pᵢ within the image (e.g., the 2D centroid coordinate), the direction of the bar (horizontal, n₁, or vertical, n₂) (as determined by S322), the known fixed distance between tag elements at opposite ends of a bar (d), and the world reference direction υ (e.g., as determined by the accelerometer). FIG. 7 shows bar points Pᵢ^{W} in the world coordinate system and corresponding points pᵢ within the image, and an actual distance λ3. As shown in FIG. 7, the distance between end points of a bar is d.

In some variations, actual distance λ₀ of bar endpoint P₀^{W} (from the center of the camera) and the actual distance λ₁ of bar endpoint P₁^{W} (from the center of the camera) of a first bar b₀ of the tag group is determined by simultaneously solving Equations 2 and 3:

d²=∥λ₁p₁−λ₀p₀∥²=λ₁²∥p₁∥²+λ₀²∥p₀∥²−λ₀λ₁(p₀·p₁) (Equation 2)

d(n₁·υ)=λ₁(p₁·υ)−λ₀(p₀·υ) (Equation 3)

As shown in Equations 2 and 3, λ₀ is the actual distance (from the center of the camera capturing the image frame) of the first bar end point P₀^{W} (of the first bar b₁) in the world coordinate system, and the 2D coordinate for the corresponding point within the image is p₀. λ₁ is the actual distance (from the center of the camera) of the second bar end point P₁^{W} in the world coordinate system, and the 2D coordinate for the corresponding point within the image is p₁. The world reference direction is υ, and the direction of the bar represented by P₀^{W} and P₁^{W} is n₁ (which is either horizontal or vertical with respect υ). The known fixed distance between P₀^{W} and P₁^{W} is d. In other words, λ₀ and λ₁ are the only unknowns in the set of Equations 2 and 3, and thus the values of λ₀ and λ₁ can be determined by solving Equations 2 and 3. In some variations, the angle between bars in a tag is known to be 90 degrees.

Similarly, in some variations, actual distance λ₂ of bar endpoint P₂^{W} (from the center of the camera) and the actual distance λ₃ of bar endpoint P₃^{W} (from the center of the camera) of a second bar b₁ of the tag group is determined by simultaneously solving Equations 4 and 5:

d²=∥λ₃p₃−λ₂p₂∥²=λ₃²∥p₃∥²+λ₂²∥p₂∥²−λ₂λ₃(p₂·p₃) (Equation 4)

d(n₂·υ)=λ₃(p₃·υ)−λ₂(p₂·υ) (Equation 5)

As shown in Equations 4 and 5, λ₂ is the actual distance (from the center of the camera capturing the image frame) of the first bar end point P₂^{W} (of the second bar b₁) in the world coordinate system, and the 2D coordinate for the corresponding point within the image is p₂. λ₃ is the actual distance (from the center of the camera) of the second bar end point P₃^{W} in the world coordinate system, and the 2D coordinate for the corresponding point within the image is p₃. The world reference direction is υ, and the direction of the bar represented by P₂^{W} and P₃^{W} is n₂ (which is either horizontal or vertical with respect υ). The known fixed distance between P₂^{W} and P₃^{W} is d. In other words, λ₂ and λ₃ are the only unknowns in the set of Equations 4 and 5, and thus the values of λ₂ and λ₃ can be determined by solving Equations 4 and 5.

Using the depth of each bar point (e.g, λ₀, λ₁, λ₂, λ₃) the 3D position of each bar end point in the camera-coordinate system is determined as λ₀p₀, λ₁p₁, λ₂p₂, λ₃p₃, respectively. Thus, the 3D positions of 4 tag points (of a two bar tag, each bar having 2 tag elements) in the camera-centered coordinate system are known. Since the camera-centric coordinate system is the same as the world coordinate system up to rotation and translation, s1 and s2 can be directly calculated by using the determined actual distances λ₀, λ₁, λ₂, λ₃ and the image coordinates p₀, p₁, p₂, p₃.

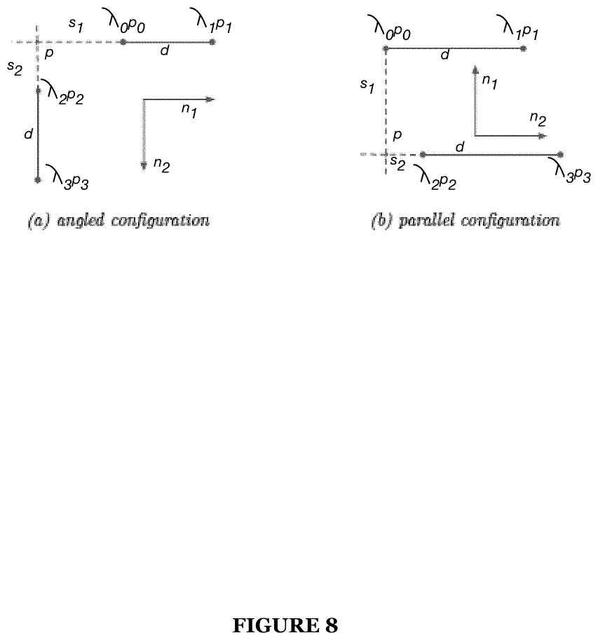

In some variations, for an angled tag (determined at S325), s1 and s2 are determined by computing an intersection point p of the lines λ₁p₁-λ₀p₀ and λ₃p₃-λ₂p₂ (shown in FIG. 8), wherein λ₁p₁-λ₀p₀ is a line representing the first bar b₀ of the tag, and λ₃p₃-λ₂p₂ is a line representing the second bar b₁ of the tag; and determining s1 and s2 by using Equations 6 and 7:

s₁=∥λ₀p₀−p∥ (Equation 6)

s₂=∥λ₂p₂−p∥ (Equation 7)

wherein the tag identifier for the angled tag is represented as (s1, s2) and either one of an identifier identifying the tag as an angled tag, or a tag angle (e.g,. (s1, s2, 90), (S1, S2, “angled”), etc.). In some variations, the tag angle is known to be 90 degrees. FIG. 8 shows the intersection point p for an angled tag.

In some variations, for a parallel tag (determined at S325), s1 and s2 are determined by computing the line perpendicular to λ₁p₁-λ₀p₀ that passes through λ₀p₀ (shown in FIG. 8) and then compute the intersection point p of the perpendicular line with λ₃p₃-λ₂p₂, wherein λ₁p₁-λ₀p₀ is a line representing the first bar b₀ of the tag, and λ₃p₃-λ₂p₂ is a line representing the second bar b₁ of the tag; and determining s1 and s2 by using Equations 6 and 7, as described above, wherein the tag identifier for the parallel tag is represented as (s1, s2). FIG. 8 shows the intersection point p for a parallel tag.

In some variations, the tag identifier for a parallel or angled tag is represented as (s₁, s₂, n₁, n₂), wherein n₁ and n₂ are directions of each bar (determined at S322).

S330 functions to retrieve information. In some variations, S330 includes retrieving information for at least one tag identifier determined in S320. In some variations, information retrieved for a tag identifier includes a 3D representation (three-space coordinates in a world coordinate system) for each tag element of the tag identified by the tag identifier. In some variations, information retrieved for a tag identifier includes a 3D representation (three-space coordinates in a world coordinate system) for at least one tag element of the tag identified by the tag identifier, and relative positions of other tag elements with respect to at least one tag element having a 3D representation. The information can be retrieved from a database, a file, a data object, a repository, a hash table, a lookup table, and the like.

In some variations, the method includes generating and storing the information to be retrieved at S330.

S340 functions to determine the position and orientation (e.g., pose). In some variations, S340 includes determining the position and orientation by using information retrieved at S330 by using at least one tag identifier determined at S320. In some variations, the position and orientation is determined by using a retrieved 3D representation for at least one tag element (retrieved by using a tag identifier) and a corresponding 2D coordinate extracted from the image used to generate the tag identifier (the 2D coordinate being a coordinate of a centroid of a blob representing the tag element of the 3D coordinate). In some variations, a tag identifier for a tag is determined, as described herein, the tag identifier is used to extract 3D coordinates (in the world coordinate system) for each tag element of the tag, and the corresponding 2D coordinates of the image (used to determine the tag ID) are used to determine the position and orientation. In some variations, a tag identifier for a tag is determined, as described herein, the tag identifier is used to extract 3D coordinates (in the world coordinate system) for each tag element of a bar end of the tag, and the corresponding 2D coordinates of the image (used to determine the tag ID) are used to determine the position and orientation.

In some variations, S340 includes using a motion tracking process to determine the position and orientation, based on retrieved 3D coordinates and corresponding 2D coordinates (extracted from the image used to determine the corresponding tag ID). In some embodiments, the motion tracking process is a perspective n-point process.

In some variations, S340 includes using conventional computer vision techniques to compute the position and orientation by using the retrieved 3D coordinate information and the 2D image coordinates (in the coordinate space of the image) of the corresponding centroids used to generate the tag identifier used to retrieve the 3D coordinate information.

In some variations, S340 includes using conventional computer vision techniques to compute the position and orientation by using the information retrieved by using the tag identifier and information extracted from the image used to generate the tag identifier used to retrieve the 3D coordinate information.

In some variations, S340 includes using conventional computer vision techniques to compute the position and orientation by using the information retrieved by using the tag identifier.

However, the position and orientation can be otherwise determined.

Reverting to FIG. 2, S240 functions to display output of an application (e.g., a collaboration application executed by the application computing device 140). In some variations, the output is displayed on a single display device. In some variations, the output is displayed across a plurality of display devices.

S250 functions to control the application based on the determined position and orientation (determined at S230).

In some variations, a display device (of a plurality of display devices included in the system 100) is identified based on the determined position and orientation.

In some variations, user selection of displayed output is identified based on the determined position and orientation.

In some variations, an application command is identified based on the determined position and orientation.

### 4. CONCLUSION

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments disclosed herein without departing from the scope of this disclosure defined in the following claims.

We claim:

1. A method comprising:
with at least one of an accelerometer and an inertial measurement unit, determining a reference direction in a world coordinate system of a collaboration system;
with a tracking camera of a collaboration system user input device, capturing an image of a display device tag of the collaboration system, wherein the display device tag comprises four tag elements that identify respective ends of two non-overlapping linear elements, wherein each linear element has a known length; and
with at least one of the user input device and a tracking system, determining absolute 3-space position and orientation of the tracking camera by using at least the captured image and the determined reference direction.

2. The method of claim 1, wherein determining absolute 3-space position and orientation of the tracking camera comprises:
using the determined reference direction, and only four 2D coordinates of centroids of blobs in the captured image that correspond to the four tag elements, to identify a tag identifier for the display device tag;
retrieving information by using the tag identifier; and
determining absolute 3-space position and orientation of the tracking camera by using the retrieved information.

3. The method of claim 2, wherein with retrieved information includes a 3D representation for at least one tag element.

4. The method of claim 1, further comprising, activating the four tag elements of the display device tag.

5. The method of claim 1, wherein at least one tag element is visible light emitter.

6. The method of claim 1, wherein at least one tag element is an infrared light emitter.

7. The method of claim 1, wherein at least one tag element is a reflector.

8. The method of claim 1, wherein the user input device is a collaboration system wand.

9. The method of claim 1, wherein the user input device is a mobile computing device.

10. The method of claim 1, wherein the display device tag comprises only four tag elements.

11. The method of claim 2, wherein the two non-overlapping linear elements are collinear, and a distance between the two non-overlapping linear elements is the tag identifier.

12. The method of claim 2, wherein the two non-overlapping linear elements are parallel, and a pair of distances is the tag identifier.

13. The method of claim 2, wherein the two non-overlapping linear elements are angled, and a pair of distances between the non-overlapping linear elements and a known angle between the two non-overlapping linear elements is the tag identifier.

14. The method of claim 1, wherein the reference direction is a gravity vector.

15. The method of claim 1, further comprising, with the collaboration system:
displaying output of a collaboration application across a plurality of display devices; and
controlling the collaboration application based on the determined absolute 3-space position and orientation of the tracking camera.

16. The method of claim 15, further comprising, with the collaboration system:
identifying a display device of the plurality of display devices based on the absolute 3-space position and orientation.

17. The method of claim 15, further comprising, with the collaboration system:
identifying user selection of displayed output based on the absolute 3-space position and orientation.

18. The method of claim 15, further comprising, with the collaboration system:
identifying a collaboration application command based on the absolute 3-space position and orientation.

19. The method of claim 1,
wherein the collaboration system includes a plurality of display device tags, and wherein the plurality of display device tags includes at least one collinear tag having two collinear non-overlapping linear elements and at least one angled tag having two angled non-overlapping linear elements,
wherein at least one of the user input device and the tracking system determines absolute 3-space position and orientation of the tracking camera over time by using at least one image of a collinear tag and at least one image of an angled tag.

20. The method of claim 19, wherein the collaboration system includes at least one display device having at least one angled tag arranged on a corner of the display device and at least one collinear tag arranged on an edge of the display device.
